(19) United States
(12) Patent Application Publication
(10) Pub. No.: US 2006/0193049 A1
(43) Pub. Date: Aug. 31, 2006

(54) Apparatus for removing water from an automobile

(76) Inventors: Chang-Hsu Chen, Taipei (TW); Chien-Chen Chuang, Taipei (TW)

Correspondence Address: CHANG-HSU CHEN, P.O. BOX 26-757, TAIPEI, 106, TW

(21) Appl. No.: 11/065,976

(22) Filed: Feb. 28, 2005

(51) Int. Cl. G02B 1/00

(52) U.S. Cl. 359/509; 359/507; 296/96.15

(57) ABSTRACT

An apparatus for removing water from an automobile, includes at least one active power disposed inside the automobile; and at least one airway one end being connected to the active power and another end disposed on a side of the automobile glass. The apparatus for removing water from an automobile of the present invention uses pumped air or an air compressor to remove water or other obscuring substances on the surface of automobile glass via an airway.

### BACKGROUND OF THE INVENTION

1. Field of the Invention

The present invention relates to an apparatus for removing water from an automobile, and more particularly, to an apparatus that uses air pumped air or an air compressor to remove water or other obscuring substances from the surface of automobile glass through an airway.

2. Description of Related Art

In a conventional apparatus for removing water from a driving mirror a brume-removal line or a small windscreen wiper is disposed on the mirror. The disadvantage of the brume-removal line is that in heavy rain it is virtually useless. The disadvantage of a small windscreen wiper is that the reflected image in the mirror is blurred whenever the wiper is on.

Another conventional apparatus for removing water from a driving mirror uses heat. The temperature of the driving mirror is raised by a power supply unit thereby evaporating the water. The disadvantage is that the device needs a certain time to reach the evaporative temperature.

Another conventional apparatus for removing water from a driving mirror is shown in FIG. 1. A bent shell 11 is disposed above the driving mirror 17. The bent shell 11 has a first opening 13 which is faces forward of the automobile so that air is driven into the first opening 13, and the second opening 15 of the shell 11 faces the driving mirror 17. When the automobile is being driven, airflow blows away water or other obscuring substances on the driving mirror 17 from the first opening 13 to the second opening 15. However, the water removing effect decreases due to the fact that rain is also driven into the first opening 13 along with the air, thereby obscuring the image that the driver is able to see in the driving mirror 17. Thus water removal is limited by the speed of the automobile.

Accordingly, as discussed above, the prior art still has some drawbacks that could be improved upon. The present invention aims to resolve the drawbacks in the prior art.

### SUMMARY OF THE INVENTION

An objective of the present invention is to provide an apparatus for removing water from an automobile using pumped air or compressed air from an airway to remove water or other obscuring substances on the surface of automobile glass. The present invention removes water and other obscuring substances without blurring the image seen in an automobile's mirror in heavy rain, and is not limited by the speed of the automobile.

For reaching the above objective, the present invention provides an apparatus for removing water from an automobile that includes: at least one active power disposed inside the automobile; and an airway with at least one end connected to the active power and another end disposed on a side of the automobile glass.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of an apparatus for removing water from an automobile driving mirror of the prior art;

FIG. 2 is a schematic view of an apparatus for removing water from an automobile in accord with a first embodiment of the present invention;

FIG. 3 is a side view of an apparatus for removing water from an automobile in accord with a first embodiment of the present invention;

FIG. 4 is a schematic view of an apparatus for removing water from an automobile in accord with a second embodiment of the present invention; and

FIG. 5 is a schematic view of an apparatus for removing water from an automobile windscreen in accord with a third embodiment of the present invention.

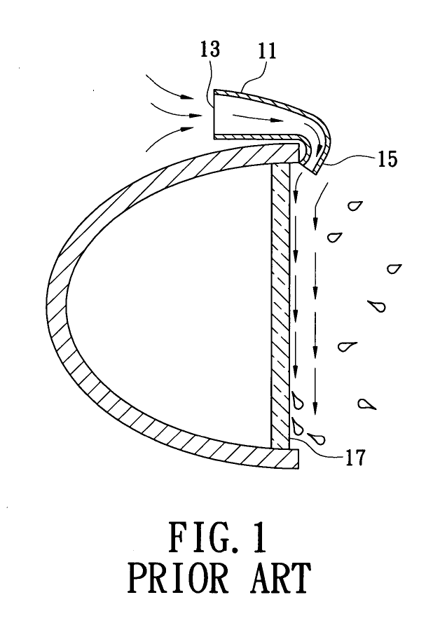

### DETAILED DESCRIPTION OF PREFERRED EMBODIMENTS

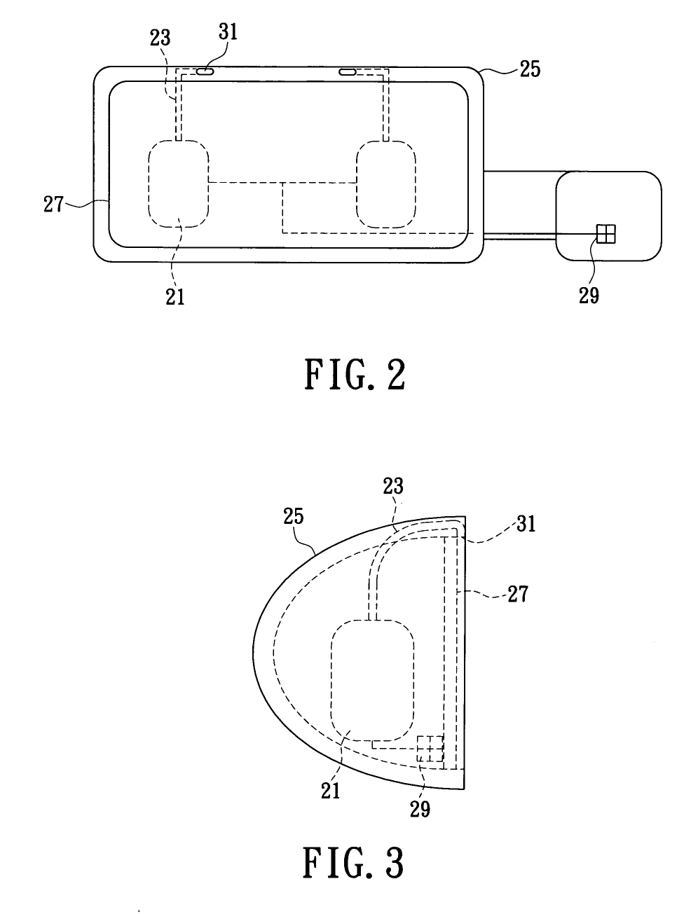

Referring to FIG. 2 and FIG. 3, an apparatus for water removal of automobile, includes at least one active power 21 and at least one airway 23. In the present embodiment, the driving mirror includes a driving mirror frame 25 and a mirror 27, wherein the active power 21 is disposed inside of the driving mirror and the active power 21 is connected to a power connection 29, and the power connection 29 is connected to the automobile power; wherein the active power 21 is an air pump or an air compressor. Wherein one end of the airway is connected to the active power 21, and another end is disposed on a side of the automobile glass; in the present embodiment, the vent 31 of the airway 23 is disposed on top of the automobile glass.

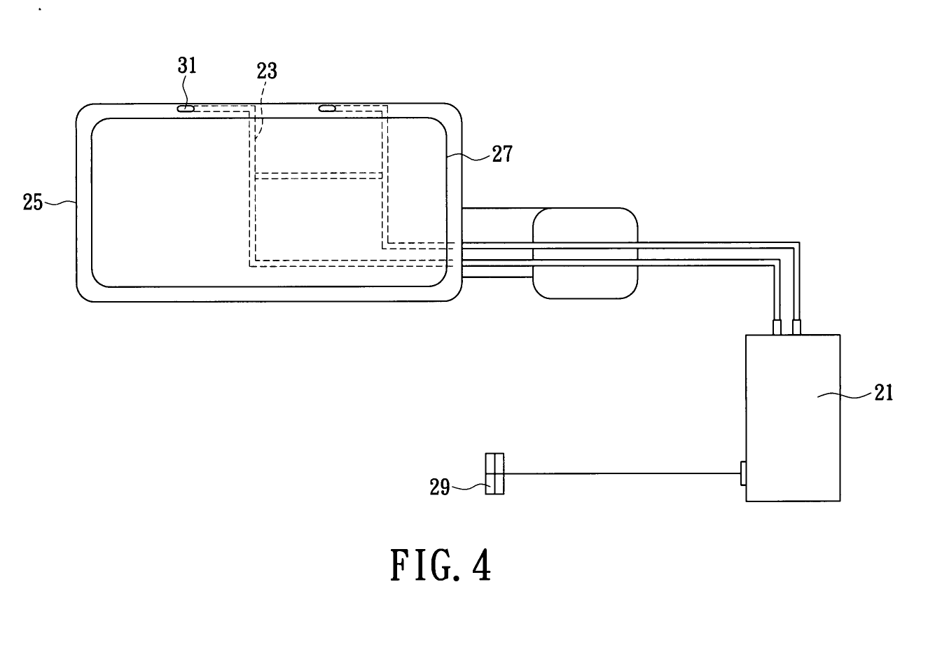

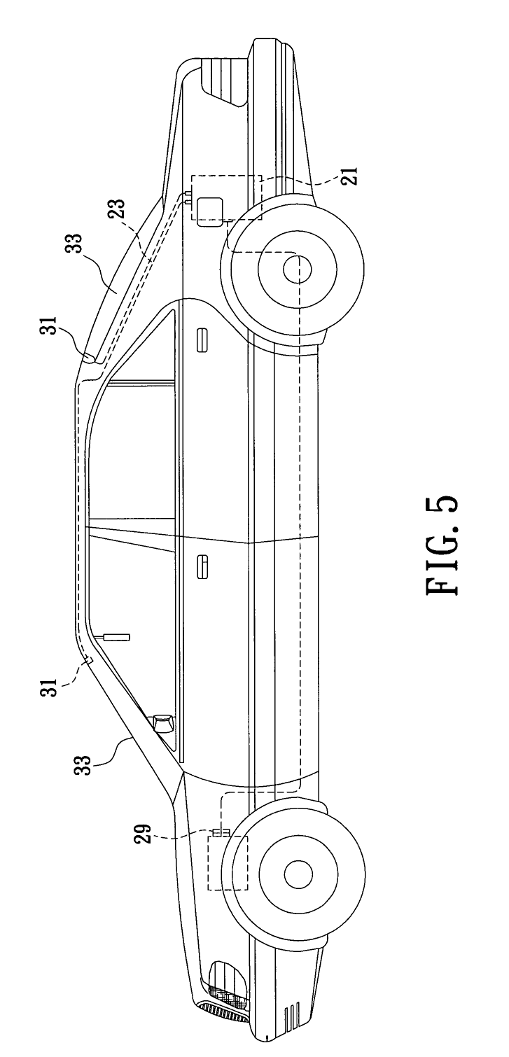

Referring to FIG. 4, wherein the active power 21 is disposed outside of the driving mirror. FIG. 5 shows another embodiment in which the apparatus for removing water from an automobile of the present invention is disposed on a top of a windscreen 33.

An apparatus for removing water from an automobile of the present invention uses pumped air or compressed air to remove water or other obscuring substances on the surface of the automobile glass via the airway 23.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. An apparatus for removing water from an automobile, particularly for removing water or other obscuring substances on the surface of automobile glass, comprising:
at least one active power disposed inside the automobile; and
at least one airway one end of which being connected to the active power and another end disposed on a side of the automobile glass.

2. The apparatus for removing water from an automobile as claimed in claim 1, wherein the active power is an air pump or an air compressor.

3. The apparatus for removing water from an automobile as claimed in claim 1, wherein the active power is connected to a power connection, and the power connection is connected to the automobile power.

4. The apparatus for removing water from an automobile as claimed in claim 1, wherein the vent of the airway is disposed on a top of the automobile glass.

5. The apparatus for removing water from an automobile as claimed in claim 1, wherein the automobile glass is the automobile's windscreen.

6. The apparatus for removing water from an automobile as claimed in claim 1, wherein the automobile glass is a driving mirror.

7. The apparatus for removing water from an automobile as claimed in claim 1, wherein the active power is disposed on the inside or outside of the driving mirror.
